(19) United States
(12) Patent Application Publication
(10) Pub. No.: US 2025/0149259 A1
(43) Pub. Date: May 8, 2025

(54) SOLID ELECTROLYTIC CAPACITOR ELEMENT, SOLID ELECTROLYTIC CAPACITOR, AND SOLID ELECTROLYTIC CAPACITOR ELEMENT MANUFACTURING METHOD

(71) Applicant: Murata Manufacturing Co., Ltd., Nagaokakyo-shi (JP)

(72) Inventor: Toshimitsu MITA, Nagaokakyo-shi (JP)

(21) Appl. No.: 19/018,482

(22) Filed: Jan. 13, 2025

Related U.S. Application Data
(63) Continuation of application No. PCT/JP2023/025689, filed on Jul. 12, 2023.

(30) Foreign Application Priority Data
Jul. 14, 2022 (JP) 2022-113148

(51) Int. Cl. H01G 9/15; H01G 9/00; H01G 9/26

(52) U.S. Cl. CPC H01G 9/15; H01G 9/0036; H01G 9/26

(57) ABSTRACT

A solid electrolytic capacitor element that includes: a valve acting metal substrate including a metal substrate layer and a porous layer on the metal substrate layer and having an anode terminal region and a cathode formation region; a dielectric layer on a surface of the porous layer in the cathode formation region; a solid electrolyte layer on the dielectric layer in the cathode formation region; a conductive layer on the solid electrolyte layer; and a mask having: a first portion dividing the valve acting metal substrate into the anode terminal region and the cathode formation region and in direct contact with the porous layer or in indirect contact with the porous layer via the dielectric layer, a second portion covering the solid electrolyte layer on the porous layer, and the mask does not cover the conductive layer.

### CROSS REFERENCE TO RELATED APPLICATIONS

The present application is a continuation of International application No. PCT/JP2023/025689, filed Jul. 12, 2023, which claims priority to Japanese Patent Application No. 2022-113148, filed Jul. 14, 2022, the entire contents of each of which are incorporated herein by reference.

### TECHNICAL FIELD

The present disclosure relates to a solid electrolytic capacitor element, a solid electrolytic capacitor, and a method of producing a solid electrolytic capacitor element.

### BACKGROUND ART

Patent Literature 1 discloses a solid electrolytic capacitor including a capacitor element, the capacitor element including: an anode foil including a first part and a second part other than the first part, the first part having an etched surface, the second part having an unetched surface; a dielectric layer provided on the surface of the first part in the anode foil; a solid electrolyte layer provided on a surface of the dielectric layer; and a cathode lead-out layer formed on a part of a surface of the solid electrolyte layer, wherein an insulating protective layer covers a boundary part between the first part and the second part and the vicinity of the boundary part as well as an end of the cathode lead-out layer and an end of the solid electrolyte layer.
Patent Literature 1: WO 2017/154374

### SUMMARY OF THE DISCLOSURE

The solid electrolytic capacitor disclosed in Patent Literature 1 can reduce the stress applied to the insulating protective layer and its vicinity but cannot suppress defects due to entry of the conductive paste during formation of the cathode lead-out layer. Specifically, since the solid electrolyte layer near the boundary between the first part and the second part is thin and thus is prone to cause a defect, a conductive paste for a cathode lead-out layer, if entered the defective portion, leads to a leakage current defect, and thus to unstable quality. A possible measure to address this issue is to improve the conductive paste processing accuracy to a high level or to narrow the region to which the conductive paste is applied. However, the former would increase the equipment costs and management costs, while the latter would sacrifice equivalent series resistance (ESR).

The present disclosure aims to solve the problems above and to provide a solid electrolytic capacitor element capable of reducing or preventing leakage current defects. The present disclosure also aims to provide a solid electrolytic capacitor including the solid electrolytic capacitor element. In addition, the present disclosure aims to provide a method of producing a solid electrolytic capacitor element that can materialize a solid electrolytic capacitor element capable of reducing or preventing leakage current defects.

The solid electrolytic capacitor element of the present disclosure includes: a valve acting metal substrate including a metal substrate layer and a porous layer on the metal substrate layer and having an anode terminal region and a cathode formation region; a dielectric layer on a surface of the porous layer in the cathode formation region; a solid electrolyte layer on the dielectric layer in the cathode formation region; a conductive layer on the solid electrolyte layer; and a mask having: a first portion dividing the valve acting metal substrate into the anode terminal region and the cathode formation region and in direct contact with the porous layer or in indirect contact with the porous layer via the dielectric layer, a second portion covering the solid electrolyte layer on the porous layer, and the mask does not cover the conductive layer.

The solid electrolytic capacitor of the present disclosure includes a plurality of solid electrolytic capacitor elements each of which is the solid electrolytic capacitor element of the present disclosure.

The method of producing a solid electrolytic capacitor element of the present disclosure includes: forming a first portion of a mask directly on a porous layer of a valve acting metal substrate or indirectly on the porous layer of the valve acting metal substrate via a dielectric layer, the first portion dividing the valve acting metal substrate into an anode terminal region and a cathode formation region; forming, after the forming of the first portion, a solid electrolyte layer on the dielectric layer in the cathode formation region; and forming, after the forming of the solid electrolyte layer, a second portion of the mask covering the solid electrolyte layer.

The present disclosure can provide a solid electrolytic capacitor element capable of reducing or preventing leakage current defects. The present disclosure can also provide a solid electrolytic capacitor including the solid electrolytic capacitor element. In addition, the present disclosure can provide a method of producing a solid electrolytic capacitor element that can materialize a solid electrolytic capacitor element capable of reducing or preventing leakage current defects.

### BRIEF DESCRIPTION OF THE DRAWINGS

FIG. 1 is a plan view schematically showing an example of a solid electrolytic capacitor element according to an embodiment of the present disclosure.

FIG. 2 is a cross-sectional view taken along line X-X of the solid electrolytic capacitor element shown in FIG. 1.

FIG. 3 is an enlarged cross-sectional view of a mask portion of the solid electrolytic capacitor element shown in FIG. 2.

FIG. 4 is an enlarged cross-sectional view of a mask portion of a solid electrolytic capacitor element according to a different embodiment from the solid electrolytic capacitor element shown in FIG. 2.

FIG. 5 is a schematic view showing an example of a step of forming a first portion of a mask on a porous layer of a valve acting metal substrate.

FIG. 6 is a schematic view showing an example of a step of forming a solid electrolyte layer.

FIG. 7 is a schematic view showing an example of a step of immersing the valve acting metal substrate on which the first portion of the mask is formed in a solid electrolyte-containing treatment liquid.

FIG. 8 is a schematic view showing an example of a step of forming a second portion of the mask on the solid electrolyte layer.

FIG. 9 is a perspective view schematically showing an example of a solid electrolytic capacitor according to the embodiment of the present disclosure.

FIG. 10 is an A-A line cross-sectional view of the solid electrolytic capacitor shown in FIG. 9.

FIG. 11 is a perspective view showing another example of the solid electrolytic capacitor according to the embodiment of the present disclosure.

FIG. 12 is a cross-sectional view taken along line B-B on the solid electrolytic capacitor shown in FIG. 11.

FIG. 13 is a perspective view schematically showing an example of a first portion of an exterior body, showing a state with some through holes seen through.

FIG. 14 is a plan view schematically showing an example of a workpiece.

FIG. 15 schematically shows an example of a step of preparing a stacked body with a plurality of solid electrolytic capacitor elements stacked on one another.

FIG. 16 schematically shows an example of a step of attaching an adhesive sheet to the first portion of the exterior body.

FIG. 17 schematically shows a step of supplying a conductive paste on the adhesive sheet.

FIG. 18A schematically shows an example of a step of inserting a stacked body into a through hole.

FIG. 18B schematically shows an example of a step of embedding the tips of the elements into the conductive paste.

FIG. 18C schematically shows an example of a step of filling the space around the elements inserted into the through hole with a liquid material.

FIG. 19 schematically shows an example of a step of cutting the first portion of the exterior body around each through hole.

FIG. 20 is a graph showing the results of measuring leakage currents of the solid electrolytic capacitors of an example and a comparative example.

### DESCRIPTION OF THE PREFERRED EMBODIMENTS

Hereinafter, the solid electrolytic capacitor element, the solid electrolytic capacitor, and the method of producing a solid electrolytic capacitor element of the present disclosure will be described.

However, the present disclosure is not limited to the following embodiments, and can be appropriately modified and applied without changing the gist of the present disclosure. The present disclosure also includes a combination of two or more of individual desirable embodiments described below.

### Solid Electrolytic Capacitor Element

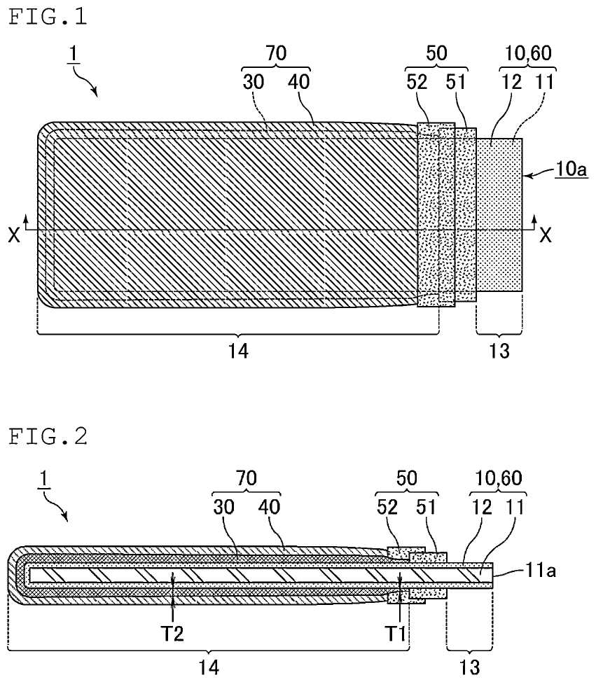

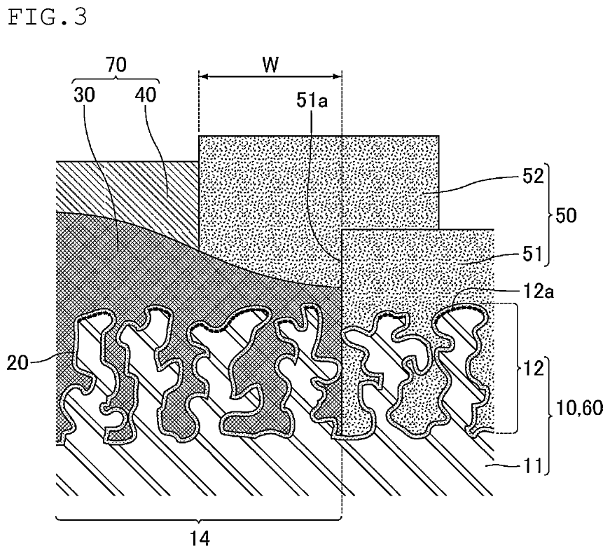

FIG. 1 is a plan view schematically showing an example of a solid electrolytic capacitor element according to an embodiment of the present disclosure. FIG. 2 is a cross-sectional view taken along line X-X of the solid electrolytic capacitor element shown in FIG. 1. FIG. 3 is an enlarged cross-sectional view of a mask portion of the solid electrolytic capacitor element shown in FIG. 2. In FIG. 1, the peripheries of a valve acting metal substrate 10 and a solid electrolyte layer 30 covered with a conductive layer 40 are indicated by dashed lines.

A solid electrolytic capacitor element 1 shown in FIG. 1 to FIG. 3 includes the valve acting metal substrate 10 including a metal substrate layer 11 and a porous layer 12 on the metal substrate layer 11 and having an anode terminal region 13 and a cathode formation region 14; a dielectric layer 20 (see FIG. 3; not shown in FIG. 1 or FIG. 2) on a surface of the porous layer 12 in the cathode formation region 14; the solid electrolyte layer 30 on the porous layer 12 via the dielectric layer 20 in the cathode formation region 14; the conductive layer 40 on the solid electrolyte layer 30; and a mask 50 having a first portion 51 and a second portion 52.

The first portion 51 divides the valve acting metal substrate 10 into the anode terminal region 13 and the cathode formation region 14 and is in contact with the porous layer 12 via the dielectric layer 20. The second portion 52 covers the solid electrolyte layer 30 on the porous layer 12. The mask 50 does not cover the conductive layer 40.

Since the first portion 51 of the mask 50 divides the valve acting metal substrate 10 into the anode terminal region 13 and the cathode formation region 14 and is in contact with the porous layer 12 via the dielectric layer 20 and the second portion 52 of the mask 50 covers the solid electrolyte layer 30 on the porous layer 12 while the mask 50 does not cover the conductive layer 40 as described above, the first portion 51 of the mask 50 is formed first, the solid electrolyte layer 30 is formed in the cathode formation region 14 next, and then the second portion 52 of the mask 50 is formed, followed by forming the conductive layer 40 on the solid electrolyte layer 30. In this process, the second portion 52 of the mask 50 covers a thin portion or a defective portion, if present, of the solid electrolyte layer 30 near the first portion 51 of the mask 50 before formation of the conductive layer 40, so that the thin portion and the defective portion can be protected. The conductive layer 40 to be formed thereafter can thus be prevented from coming into contact with the valve acting metal substrate 10 via the dielectric layer 20 in the thin portion or the defective portion. As a result, the occurrence of leakage current defects due to the contact can be reduced or prevented.

To more effectively reduce or prevent leakage current defects, as shown in FIG. 3, the second portion 52 preferably covers the solid electrolyte layer 30 to a point at least 50 μm (more preferably 100 μm, still more preferably 300 μm) away from an edge 51a of the first portion 51 adjacent to the cathode formation region 14. In other words, a width W of the second portion 52 from the edge 51a of the first portion 51 adjacent to the cathode formation region 14 is preferably 50 μm or greater, more preferably 100 μm or greater, still more preferably 300 μm or greater.

To reduce the ESR, the second portion 52 preferably does not cover the solid electrolyte layer 30 at any point more than 500 μm (more preferably 300 μm, still more preferably 100 μm) away from the edge 51a of the first portion 51 adjacent to the cathode formation region 14. In other words, the width W of the second portion 52 from the edge 51a of the first portion 51 adjacent to the cathode formation region 14 is preferably 500 μm or smaller, more preferably 300 μm or smaller, still more preferably 100 μm or smaller.

The second portion 52 preferably covers at least a part of the first portion 51. This structure can prevent a gap between the first portion 51 and the second portion 52, exposure of a thin portion and a defective portion of the solid electrolyte layer 30 in the gap, and thus contact between the conductive layer 40 and the valve acting metal substrate 10 via the dielectric layer 20 in the exposed thin portion and defective portion. In other words, leakage current defects can be more effectively reduced or prevented.

As shown in FIG. 2, a thickness T1 of the solid electrolyte layer 30 near the first portion 51 may be smaller than a thickness T2 of the solid electrolyte layer 30 in the central portion of the solid electrolyte layer 30. In such a case, leakage current defects can be more effectively reduced or prevented as described above.

In the above case, the thickness T1 of the solid electrolyte layer 30 may be smaller than the thickness T2 of the solid electrolyte layer 30 on each main face side of the valve acting metal substrate 10. The solid electrolyte layer 30 may also have, on each main face side of the valve acting metal substrate 10, a thickness that gradually decreases from near one end of the valve acting metal substrate 10 (the end farthest from the mask 50) toward the other end (the first portion 51 of the mask 50).

Although FIG. 2 shows a case where the first portion 51 and the second portion 52 are provided on each main face of the valve acting metal substrate 10, the first portion 51 and the second portion 52 are preferably provided on at least one main face of the valve acting metal substrate 10. The valve acting metal substrate 10 has a pair of main faces facing each other and a plurality of (usually four) side faces connecting between the pair of main faces. Since the area of the pair of main faces is large, the first portion 51 and the second portion 52 on at least one main face (more preferably each main face) of the valve acting metal substrate 10 enable more effective reduction or prevention of leakage current defects.

From the same perspective, the first portion 51 and the second portion 52 are preferably provided in an annular pattern (for example, quadrilateral ring pattern) surrounding the valve acting metal substrate 10. In other words, the first portion 51 and the second portion 52 are preferably provided on the pair of main faces and a pair of side faces of the valve acting metal substrate 10.

Although FIG. 3 shows an embodiment where the first portion 51 of the mask 50 is in contact with the porous layer 12 via the dielectric layer 20, the first portion 51 of the mask 50 may be in direct contact with the porous layer 12.

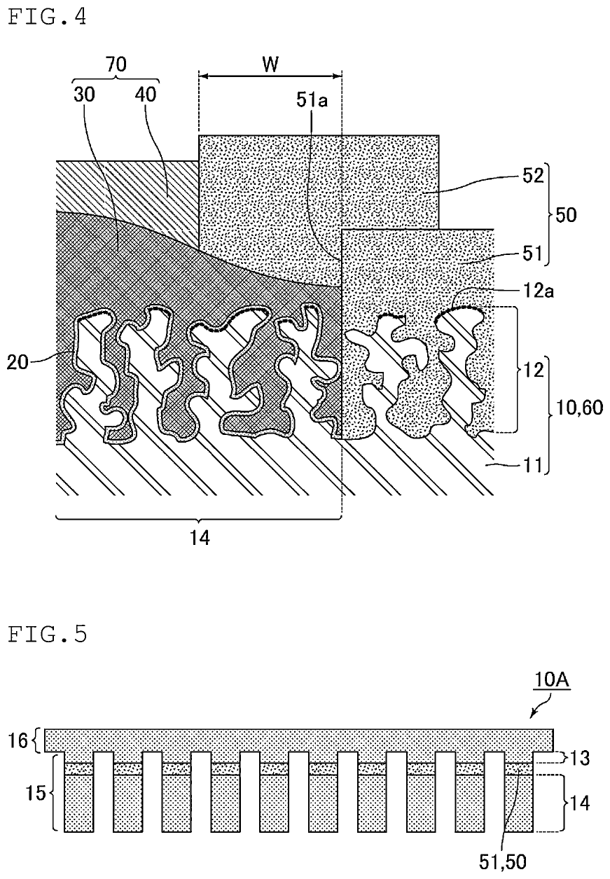

FIG. 4 is an enlarged cross-sectional view of a mask portion of a solid electrolytic capacitor element according to a different embodiment from the solid electrolytic capacitor element shown in FIG. 2. FIG. 4 shows an embodiment where the first portion 51 of the mask 50 is in direct contact with the porous layer 12 without the dielectric layer 20 in between. The rest of the structure is the same as that of the mask portion shown in FIG. 3. The effect exerted by providing the mask 50 is the same as the effect exerted by the solid electrolytic capacitor element in the embodiments shown in FIG. 2 and FIG. 3.

The structures of the solid electrolytic capacitor element 1 are described in detail below.

The valve acting metal substrate 10 is a thin film (foil) and has a tetragonal shape in a plan view, preferably a rectangular (strip) shape with a pair of long sides and a pair of short sides in a plan view. The valve acting metal substrate 10 functions as an anode 60 of the solid electrolytic capacitor element 1.

Herein, the term “plan view” means a view in the direction of the normal of the main face of the valve acting metal substrate.

As shown in FIG. 3 and FIG. 4, the valve acting metal substrate 10 includes the metal substrate layer 11 and the porous layer 12 with a plurality of recesses. Thus, each main face of the valve acting metal substrate 10 is porous. Since the main face is porous, the valve acting metal substrate 10 has a large surface area. The present disclosure is not limited to a case where both main faces of the valve acting metal substrate 10 are porous (porous layer 12), and only one of the main faces of the valve acting metal substrate 10 may be porous (porous layer 12).

The metal substrate layer 11 is the core metal portion of the valve acting metal substrate 10 and has a substantially constant thickness as shown in FIG. 2.

The valve acting metal substrate 10 is made of, for example, a valve acting metal such as a single metal, e.g., aluminum, tantalum, niobium, titanium, or zirconium, or an alloy containing at least one of these metals. An oxide film can be formed on the surface of the valve acting metal.

The valve acting metal substrate 10 only needs to include a metal substrate layer and a porous layer provided on at least one main face of the metal substrate layer, and one obtained by etching the surface of the metal foil, one obtained by forming a porous fine powder sintered body on the surface of the metal foil, or the like can be appropriately used.

The dielectric layer 20 is provided on the surface of the porous layer 12 of the valve acting metal substrate 10 (see FIG. 3). In the embodiment shown in FIG. 3, the dielectric layer 20 is provided entirely on the valve acting metal substrate 10 except for one end face 11a (see FIG. 2) of the metal substrate layer 11. In the embodiment shown in FIG. 4, the dielectric layer 20 is provided entirely on the valve acting metal substrate 10 except for the one end face 11a (see FIG. 2) of the metal substrate layer 11 and the part just under the first portion 51 of the mask 50.

The dielectric layer 20 only needs to be provided on at least one of the main faces of the valve acting metal substrate 10 except for at least the end face 11a.

The dielectric layer 20 preferably includes an oxide film provided on the surface of the porous layer 12 of the valve acting metal substrate 10. For example, the dielectric layer 20 includes an aluminum oxide. The aluminum oxide is formed by anodizing the surface of the valve acting metal substrate as described later.

The mask 50 is an insulating component provided along one side 10a (preferably, a short side) of the valve acting metal substrate 10. The mask 50 separates the anode 60 and a cathode 70 of the solid electrolytic capacitor element 1 to ensure insulation between the anode 60 and the cathode 70 of the solid electrolytic capacitor element 1. The first portion 51 of the mask 50 divides the valve acting metal substrate 10 into the anode terminal region 13 and the cathode formation region 14. The mask 50 is provided linearly (extending in a belt-like shape) along the side 10a of the valve acting metal substrate 10.

The mask 50 (first portion 51) is provided a predetermined distance away from the side 10a of the valve acting metal substrate 10 but may extend to just before the edge of the side 10a. In this case, the end face on the side 10a of the valve acting metal substrate 10 corresponds to the anode terminal region 13. The mask 50 is provided on the pair of main faces and a pair of side faces of the valve acting metal substrate 10 via the dielectric layer 20 but may be provided, as with the dielectric layer 20, on at least one of the pair of main faces (the main face(s) where the dielectric layer 20 is provided) of the valve acting metal substrate 10.

The mask 50, as described above, has the first portion 51 in contact with the porous layer 12 via the dielectric layer 20 and the second portion 52 covering the solid electrolyte layer 30 on the porous layer 12. The first portion 51 divides the valve acting metal substrate 10 into the anode terminal region 13 and the cathode formation region 14 and mainly functions as an insulating mask that prevents the solid electrolyte layer 30 from entering the anode terminal region 13. The second portion 52 mainly functions as a protective mask that protects a thin portion and a defective portion of the solid electrolyte layer 30 by covering them. The second portion 52 also limits the area to which the conductive layer 40 is applied. The second portion 52 covers only a part of the solid electrolyte layer 30, in particular, a part of the solid electrolyte layer 30 adjacent to the first portion 51.

As shown in FIG. 3 and FIG. 4, the first portion 51 of the mask 50 is preferably provided so as to fill a plurality of pores (recesses) of the valve acting metal substrate 10. Yet, it is sufficient that a part of the outer surface of the dielectric layer 20 is covered with the first portion 51 of the mask 50, and pores (recesses) of the porous layer 12 not filled with the first portion 51 of the mask 50 may be present.

The first portion 51 of the mask 50 is continuously present from the pores of the porous layer 12 filled with the first portion 51 toward the opposite side of the metal substrate layer 11. The solid electrolyte layer 30 is absent between the first portion 51 of the mask 50 and an outermost surface 12a (the surface emerging on the outermost side of the porous layer 12; see the thick dashed lines in FIG. 3 and FIG. 4) of the porous layer 12. In the case where a plurality of pores of the porous layer 12 not filled with the first portion 51 of the mask 50 are present on the metal substrate layer 11 side, these pores may be filled with the solid electrolyte layer 30.

As shown in FIG. 3 and FIG. 4, the second portion 52 of the mask 50 further covers the solid electrolyte layer 30 that covers the outermost surface 12a of the porous layer 12. In other words, the solid electrolyte is present as a layer between the second portion 52 of the mask 50 and the outermost surface 12a of the porous layer 12, and the second portion 52 of the mask 50 does not fill the pores (recesses) of the valve acting metal substrate 10 (porous layer 12).

The mask 50 (first portion 51 and second portion 52) contains an insulating material. The mask 50 is formed, for example, by applying a mask material such as a composition containing an insulating resin. Examples of the insulating resin include polyphenylsulfone (PPS), polyethersulfone (PES), a cyanate ester resin, a fluororesin (tetrafluoroethylene, tetrafluoroethylene-perfluoroalkyl vinyl ether copolymers, etc.), a composition containing a soluble polyimide siloxane and an epoxy resin, a polyimide resin, a polyamideimide resin, and derivatives or precursors thereof.

The first portion 51 and the second portion 52 of the mask 50 may be made of the same insulating material or different insulating materials. In the former case, the interface as shown in FIG. 3 and FIG. 4 may be absent between the first portion 51 and the second portion 52. Also in this case, the portion in contact with the porous layer 12 via the dielectric layer 20 or directly is defined as the first portion 51 and the portion covering the solid electrolyte layer 30 on the porous layer 12 is defined as the second portion 52.

The mask material can be applied by, for example, a method such as screen printing, roller transfer, dispenser application, or inkjet printing.

The solid electrolytic capacitor element 1 includes the solid electrolyte layer 30 on the dielectric layer 20 and the conductive layer 40 on the solid electrolyte layer 30. These layers function as the cathode 70 of the solid electrolytic capacitor element 1. The cathode 70 is provided on the dielectric layer 20 in the cathode formation region 14 of the valve acting metal substrate 10, divided by the first portion 51 of the mask 50.

The solid electrolyte layer 30 is provided on the dielectric layer 20. As shown in FIG. 3 and FIG. 4, the solid electrolyte layer 30 is preferably provided so as to fill a plurality of pores (recesses) of the valve acting metal substrate 10 (porous layer 12). Yet, it is sufficient that a part of the outer surface of the dielectric layer 20 is covered with the solid electrolyte layer 30, and pores (recesses) of the porous layer 12 not filled with the solid electrolyte layer 30 may be present.

The solid electrolyte layer 30 is provided on the dielectric layer 20 in the cathode formation region 14 of the valve acting metal substrate 10, divided by the first portion 51 of the mask 50.

As a material constituting the solid electrolyte layer 30, for example, conductive polymers such as polypyrroles, polythiophenes, and polyanilines are used. Polythiophenes are preferred, and poly(3,4-ethylenedioxythiophene) called PEDOT is particularly preferred among these. The conductive polymer may contain a dopant such as polystyrene sulfonates (PSS).

The solid electrolyte layer 30 is formed by, for example, a method of forming a polymerized film of a conductive polymer such as poly(3,4-ethylenedioxythiophene) on the surface of the dielectric layer 20 using a solution containing a polymerizable monomer such as 3,4-ethylenedioxythiophene or a method of applying a dispersion of a conductive polymer such as poly(3,4-ethylenedioxythiophene) on the surface of the dielectric layer 20 and drying the dispersion.

It is preferable to form an outer layer covering the entire dielectric layer 20 after forming an inner layer filling the pores (recesses) of the valve acting metal substrate 10. The inner layer can be formed by, for example, an immersion method, electrolytic polymerization, sponge transfer, screen printing, dispenser application, or inkjet printing. Similarly, the outer layer can be formed by, for example, an immersion method, electrolytic polymerization, sponge transfer, screen printing, dispenser application, or inkjet printing.

The conductive layer 40 is provided on the solid electrolyte layer 30. The conductive layer 40 covers substantially the entire region of the solid electrolyte layer 30 except for the region covered with the second portion 52 of the mask 50, and is in contact with the second portion 52 of the mask 50. The conductive layer 40 may be provided to cover at least a part of the second portion 52 of the mask 50 or may extend to just before the edge of the second portion 52 of the mask 50 without contact with the second portion 52 of the mask 50. The conductive layer 40 has a substantially constant thickness.

The conductive layer 40 includes a carbon layer or a negative conductor layer, for example. The conductive layer 40 may be a composite layer of a carbon layer and a negative conductor layer on the outer surface of the carbon layer or may be a mixed layer containing carbon and negative conductor layer materials.

The carbon layer is formed by a method in which a carbon paste containing carbon particles and a resin is applied to the surface of the solid electrolyte layer 30 and dried, for example.

The carbon paste can be applied by, for example, an immersion method, sponge transfer, screen printing, spray coating, dispenser application, or inkjet printing.

The negative conductor layer is formed by, for example, a method in which a conductive paste containing metal particles such as gold, silver, copper, or platinum particles and a resin is applied to the surface of the solid electrolyte layer or the carbon layer and dried. The negative conductor layer is preferably a silver layer.

The conductive paste can be applied by, for example, an immersion method, sponge transfer, screen printing, spray coating, dispenser application, or inkjet printing.

### Method of Producing Solid Electrolytic Capacitor Element

The method of producing a solid electrolytic capacitor element 1 will be described below. In the following example, a method of simultaneously producing a plurality of solid electrolytic capacitor elements using a large-sized valve acting metal substrate will be described.

FIG. 5 is a schematic view showing an example of a step of forming a first portion of a mask on a porous layer of a valve acting metal substrate.

As shown in FIG. 5, the first portion 51 of the mask 50 is formed on a porous layer (not shown) of a valve acting metal substrate 10A via a dielectric layer (not shown). The first portion 51 divides the valve acting metal substrate 10A into the anode terminal region 13 and the cathode formation region 14.

Specifically, first, the valve acting metal substrate 10A including a metal substrate layer (not shown) and a porous layer on the metal substrate layer is cut by laser processing, punching, or another processing to be processed into a shape including the plurality of element portions 15 and a support portion 16. Each of the element portions 15 has a strip shape and protrudes from the support portion 16.

Next, the first portion 51 of the mask 50 is formed on both of the main faces and both of the side faces of each element portion 15 along the short side of each element portion 15.

The first portion 51 of the mask 50 is formed, for example, by applying a mask material such as a composition containing an insulating resin by a method such as screen printing, roller transfer, dispenser application, or inkjet printing. Examples of the insulating resin include polyphenylsulfone (PPS), polyethersulfone (PES), a cyanate ester resin, a fluororesin (tetrafluoroethylene, tetrafluoroethylene-perfluoroalkyl vinyl ether copolymers, etc.), a composition containing a soluble polyimide siloxane and an epoxy resin, a polyimide resin, a polyamideimide resin, and derivatives or precursors thereof.

Thereafter, the valve acting metal substrate 10A is anodized to form an oxide film to be the dielectric layer on the surface of the valve acting metal substrate 10A (porous layer). At this time, the oxide film is also formed on the side faces of each element portion 15 cut by laser processing, punching, or another processing. Since this step does not form the dielectric layer on the portion where the surface of the valve acting metal substrate 10A (porous layer) is covered with the first portion 51 of the mask 50, the first portion 51 of the mask 50 is in direct contact with the porous layer without the dielectric layer in between.

Here, chemical conversion foil on which an oxide of the valve acting metal is already formed may be used as the valve acting metal substrate 10A. Also in this case, the valve acting metal substrate 10A after cutting is anodized to form an oxide film on the side faces of each cut element portion 15. When such chemical conversion foil is used as the valve acting metal substrate 10A, the first portion 51 of the mask 50 is in contact with the porous layer via the dielectric layer.

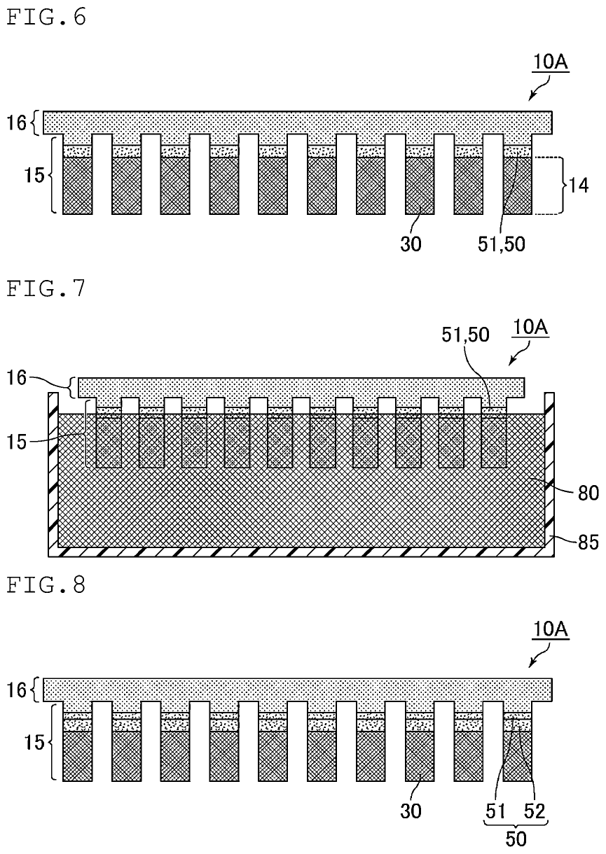

FIG. 6 is a schematic view showing an example of a step of forming a solid electrolyte layer.

FIG. 7 is a schematic view showing an example of a step of immersing the valve acting metal substrate on which the first portion of the mask is formed in a solid electrolyte-containing treatment liquid.

After the first portion 51 has been formed, as shown in FIG. 6, the solid electrolyte layer 30 is formed on the porous layer via the dielectric layer in the cathode formation region 14.

Specifically, as shown in FIG. 7, the element portions 15 are immersed from the front end side in the solid electrolyte-containing treatment liquid 80 until the liquid comes into contact with the first portion 51 of the mask 50, so that the porous layer of the valve acting metal substrate 10A is impregnated with the treatment liquid 80. The treatment liquid 80 is continuously supplied to a treatment tank 85. After immersion for a predetermined time, the element portions 15 are pulled up from the treatment liquid 80 and then dried at a predetermined temperature for a predetermined time. The immersion into the treatment liquid 80, pulling up, and drying are repeated a predetermined number of times, whereby the solid electrolyte layer 30 is formed.

As the solid electrolyte-containing treatment liquid 80, for example, a dispersion of a conductive polymer such as a polypyrrole, a polythiophene, or a polyaniline is used. A conductive polymer film can be formed by attaching the dispersion of the conductive polymer to the outer surface of the dielectric layer 20 and drying the dispersion. Alternatively, as the solid electrolyte-containing treatment liquid 80, a solution containing a polymerizable monomer, for example, 3,4-ethylenedioxythiophene and an oxidizing agent may be used. A conductive polymer film can be formed by chemical polymerization after attaching the solution containing a polymerizable monomer to the outer surface of the dielectric layer 20. This conductive polymer film becomes the solid electrolyte layer 30.

FIG. 8 is a schematic view showing an example of a step of forming a second portion of the mask on the solid electrolyte layer.

As shown in FIG. 8, after the solid electrolyte layer 30 has been formed, the second portion 52 of the mask 50 covering the solid electrolyte layer 30 is formed. Specifically, the second portion 52 of the mask 50 is formed on both of the main faces and both of the side faces of each element portion 15 along the first portion 51 of the mask 50.

The second portion 52 of the mask 50 formed covers a thin portion and a defective portion, if present, of the solid electrolyte layer 30 near the first portion 51 of the mask 50 before the formation of the conductive layer 40, so that the thin portion and the defective portion can be protected. As a result, the occurrence of leakage current defects can be reduced or prevented as described above.

The second portion 52 of the mask 50 is formed, for example, by applying a mask material such as a composition containing an insulating resin by a method such as screen printing, roller transfer, dispenser application, or inkjet printing. Examples of the insulating resin include polyphenylsulfone (PPS), polyethersulfone (PES), a cyanate ester resin, a fluororesin (tetrafluoroethylene, tetrafluoroethylene-perfluoroalkyl vinyl ether copolymers, etc.), a composition containing a soluble polyimide siloxane and an epoxy resin, a polyimide resin, a polyamideimide resin, and derivatives or precursors thereof.

Thereafter, a carbon paste is applied to the surface of the solid electrolyte layer 30 and dried, so that a carbon layer is formed on the cathode formation region 14. For example, the element portions 15 are immersed in a carbon paste, pulled up from the carbon paste, and dried, so that a carbon layer is formed. The carbon paste may be applied by the immersion method or another method such as sponge transfer, screen printing, dispenser application, or inkjet printing. The carbon paste is a conductive paste containing carbon particles as its conductive component and a resin component such as an epoxy resin or a phenol resin.

Then, a conductive paste is then applied to the surface of the carbon layer and dried, so that a negative conductor layer is formed in the cathode formation region 14. For example, the element portions 15 are immersed in a conductive paste, pulled up from the conductive paste, and dried, so that a negative conductor layer is formed. The conductive paste may be applied by the immersion method or another method such as sponge transfer, screen printing, dispenser application, or inkjet printing. The conductive paste for forming a negative conductor layer may be one containing, for example, metal particles as its conductive component and a resin component such as an epoxy resin or a phenol resin. Examples of the metal particles include gold, silver, copper, and platinum particles. A suitable conductive paste for forming a negative conductor layer is a silver paste containing silver particles as its conductive component.

Lastly, the element portions 15 are separated by cutting the valve acting metal substrate 10A to form strip-shaped pieces of the valve acting metal substrate 10A.

The solid electrolytic capacitor elements 1 can be obtained through the above-described steps.

### Solid Electrolytic Capacitor

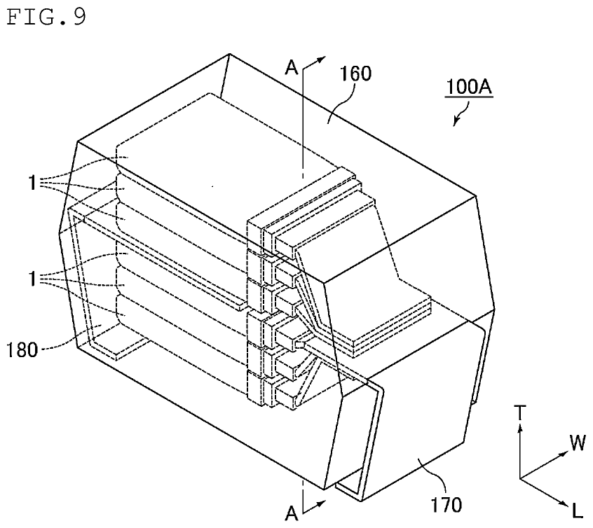

FIG. 9 is a perspective view schematically showing an example of a solid electrolytic capacitor according to the embodiment of the present disclosure.

A solid electrolytic capacitor 100A shown in FIG. 9 includes a sealing body 160 having a plurality of solid electrolytic capacitor elements 1 sealed with a sealing material, and includes a lead frame 170 connected to the anodes of the solid electrolytic capacitor elements 1, and a lead frame 180 connected to the cathodes of the solid electrolytic capacitor elements 1.

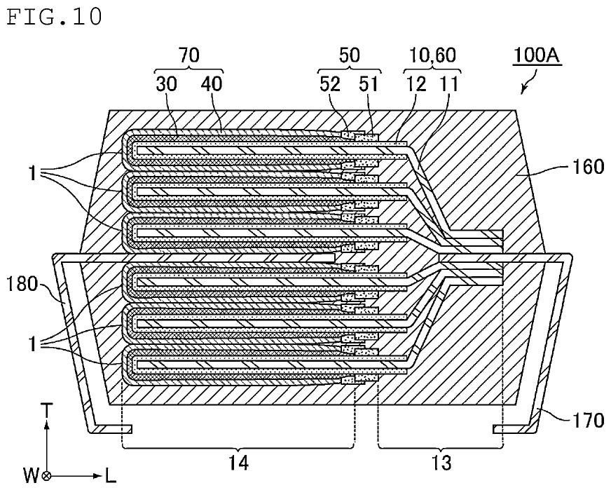

In FIG. 9 and FIG. 10, the length direction (longitudinal direction), the width direction, and the height direction of the solid electrolytic capacitor 100A are indicated by L, W, and T, respectively. Here, the length direction L, the width direction W, and the height direction T are orthogonal to each other.

The longitudinal direction of the solid electrolytic capacitor is also the longitudinal direction of the lead frames.

FIG. 10 is an A-A line cross-sectional view of the solid electrolytic capacitor shown in FIG. 9.

The solid electrolytic capacitor 100A shown in FIG. 10 includes the plurality of solid electrolytic capacitor elements 1, the lead frame 170 connected to the valve acting metal substrates 10 which function as the anodes 60 of the solid electrolytic capacitor elements 1, the lead frame 180 connected to the conductive layers 40 which function as the cathodes 70 of the solid electrolytic capacitor elements 1, and the sealing body 160 formed from a sealing material.

The sealing body 160 (sealing material) seals the plurality of solid electrolytic capacitor elements 1.

The sealing body 160 is formed so as to cover the whole of each solid electrolytic capacitor element 1, a part of the lead frame 170, and a part of the lead frame 180. Examples of the material of the sealing body 160 (sealing material) include epoxy resins.

Each solid electrolytic capacitor element 1, as described above, includes a valve acting metal substrate 10, a dielectric layer (not shown), a solid electrolyte layer 30, a conductive layer 40, and a mask 50. The valve acting metal substrate 10 includes a metal substrate layer 11 and a porous layer 12 on the metal substrate layer 11 and has an anode terminal region 13 and a cathode formation region 14. The mask 50 includes a first portion 51 that is in contact with the porous layer 12 via a dielectric layer or directly and a second portion 52 that covers the solid electrolyte layer 30 on the porous layer 12 but does not cover the conductive layer 40.

On the anode terminal region 13 side, the valve acting metal substrates 10 of the solid electrolytic capacitor elements 1 are put together by the lead frame 170 and drawn out of the sealing material (sealing body 160).

On the cathode formation region 14 side, the conductive layers 40 of the solid electrolytic capacitor elements 1 are electrically connected to one another. Further, the conductive layers 40 are electrically connected to the lead frame 180 and drawn out of the sealing material (the sealing body 160).

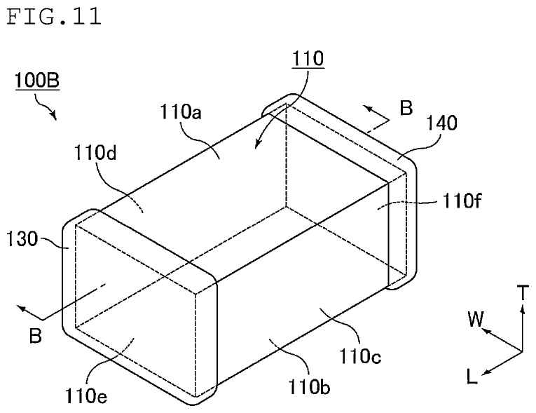

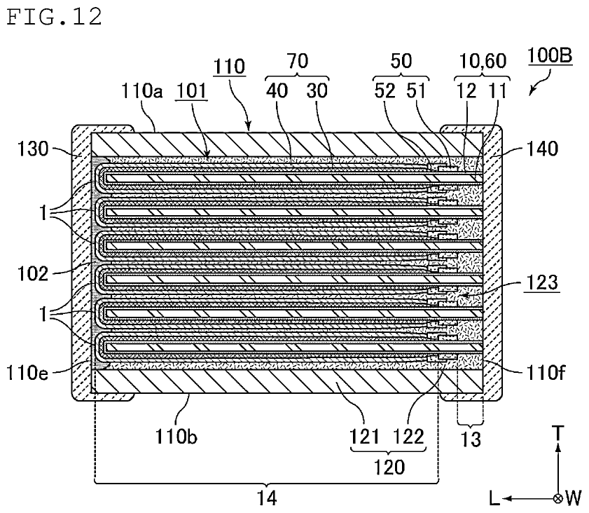

FIG. 11 is a perspective view showing another example of the solid electrolytic capacitor according to the embodiment of the present disclosure. FIG. 12 is a cross-sectional view taken along line B-B on the solid electrolytic capacitor shown in FIG. 11.

In FIG. 11 and FIG. 12, the length direction (longitudinal direction), the width direction, and the height direction of a solid electrolytic capacitor 100B and an element body 110 are indicated by L, W, and T, respectively. Here, the length direction L, the width direction W, and the height direction T are orthogonal to each other.

As shown in FIG. 11 and FIG. 12, the solid electrolytic capacitor 100B has a substantially rectangular parallelepiped outer shape. The solid electrolytic capacitor 100B includes the element body 110, a first external electrode 130, and a second external electrode 140.

The element body 110 includes a stacked body 101 including a stack of solid electrolytic capacitor elements 1 (hereinbelow, also abbreviated as “elements 1” in some cases). The element body 110 further includes an exterior body 120 and a current collector electrode 102.

The number of elements 1 in the stacked body 101 is not limited as long as it is 2 or more and can be set as appropriate.

The element body 110 has a substantially rectangular parallelepiped outer shape. The element body 110 has a first main face 110a and a second main face 110b facing each other in the height direction T, a first side face 110c and a second side face 110d facing each other in the width direction W, and a first end face 110e and a second end face 110f facing each other in the length direction L.

As described above, although the element body 110 has a substantially rectangular parallelepiped outer shape, corner portions and ridge portions may be rounded. A corner portion is a portion where three surfaces of the element body 110 intersect each other. A ridge portion is a portion where two surfaces of the element body 110 intersect each other.

The first external electrode 130 is formed on the first end face 110e of the element body 110. The second external electrode 140 is formed on the second end face 110f of the element body 110.

The plurality of elements 1 are stacked in the height direction T. An extending direction of each of the plurality of elements 1 is substantially parallel to the first main face 110a and the second main face 110b of the element body 110. Elements 1 adjacent to each other in the height direction T may be bonded to each other with a conductive adhesive (not shown) interposed therebetween.

Each solid electrolytic capacitor element 1 includes, as described above, a valve acting metal substrate 10, a dielectric layer (not shown), a solid electrolyte layer 30, a conductive layer 40, and a mask 50. The valve acting metal substrate 10 includes a metal substrate layer 11 and a porous layer 12 on the metal substrate layer 11 and has an anode terminal region 13 and a cathode formation region 14. The mask 50 includes a first portion 51 that is in contact with the porous layer 12 via a dielectric layer or directly and the second portion 52 that covers the solid electrolyte layer 30 on the porous layer 12 but that does not cover the conductive layer 40.

As shown in FIG. 12, the exterior body 120 seals the plurality of elements 1. In other words, the stacked body 101 of the plurality of elements 1 is embedded in the exterior body 120. The exterior body 120 also seals the current collector electrode 102. The exterior body 120 includes a first portion 121 including a first resin material and a second portion 122 including a second resin material.

The first portion 121 has a tube structure (for example, quadrilateral tube structure) having a through hole 123 and houses the plurality of elements 1 (stacked body 101) in the through hole 123. The second portion 122 is present inside the through hole 123 in which the plurality of elements 1 (stacked body 101) are housed.

The “quadrilateral tube structure” refers to a structure in which the outer peripheral surface of a tube structure includes four flat faces and all two adjacent faces among the four faces intersect (preferably, are orthogonal to) each other, and the shape of the through hole 123 is not limited.

The second portion 122 fills the through hole 123 in which the plurality of elements 1 (stacked body 101) are housed. In other words, the second portion 122 fills the space that is the inside of the first portion 121 and around the plurality of elements 1 (stacked body 101).

The state where the second portion 122 fills the through hole 123 in which the plurality of elements 1 (stacked body 101) are housed may refer to a state where the space that is inside the first portion 121 and around the plurality of elements 1 (stacked body 101) is filled with the second portion 122 completely or a state where the space is left partially filled with the second portion 122. In the latter case, for example, the second portion 122 may contain a few air bubbles trapped, a small gap may be left between the second portion 122 and the first portion 121, or a small gap may be left between the second portion 122 and at least one element 1.

The first resin material may be the same material as the second resin material but is preferably a material different from the second resin material.

The first resin material of the first portion 121 is preferably a resin that can be injection molded. Specifically, thermoplastic resins such as polyphenylene sulfide (PPS), a liquid crystal polymer (LCP), polybutylene terephthalate (PBT), polyimide, and polyamide are preferred. The first resin material may contain, as a reinforcing material, a filler such as silica particles, alumina particles, or metal particles, or fibers such as ceramic fibers.

The second resin material of the second portion 122 is preferably a thermosetting resin such as epoxy resin, silicon resin, or urethane resin. The second resin material may contain, as a reinforcing material, a filler such as silica particles, alumina particles, or metal particles, or fibers such as ceramic fibers.

As shown in FIG. 12, the current collector electrode 102 is electrically connected to the plurality of cathodes 70 of the plurality of elements 1. The current collector electrode 102 is exposed at the first end face 110e of the element body 110 and is provided at least on the first end face 110e side of the element body 110. Moreover, the current collector electrode 102 is formed in a shape that is internally thick to a position inward from the first end face 110e.

As shown in FIG. 12, at least the first external electrode 130 side portion of each cathode 70 is embedded in the current collector electrode 102, which ensures electrical connection between each cathode 70 and the current collector electrode 102.

The current collector electrode 102 is a composite material of a conductive component (conductive material) and a resin component (resin material). The conductive component preferably contains, as a main component, a simple metal such as silver, copper, nickel, or tin, an alloy containing at least one of these metals, or the like. The resin component preferably contains an epoxy resin, a phenol resin, or the like as a main component. The current collector electrode 102 can be formed from a conductive paste such as a silver paste, for example.

As shown in FIG. 12, the first external electrode 130 is provided on the first end face 110e of the element body 110. In FIG. 11, the first external electrode 130 is provided over the first main face 110a, the second main face 110b, the first side face 110c, and the second side face 110d from the first end face 110e of the element body 110. The first external electrode 130 is electrically connected to the current collector electrode 102 exposed at the first end face 110e from the element body 110. In other words, the first external electrode 130 is electrically connected to the cathodes 70 via the current collector electrode 102.

The current collector electrode 102 is present in the through hole 123 in which the plurality of elements 1 (stacked body 101) are housed, and the current collector electrode 102 and the first portion 121 of the exterior body 120 form the first end face 110e of the element body 110, so that the first external electrode 130 can be formed on the first end face 110e. Thus, the first external electrode 130 and the current collector electrode 102 can be easily electrically connected, and the first external electrode 130 can be made thin.

Specifically, the first external electrode 130 may include what is called a sputtered film formed by sputtering. The material of the sputtered film may be, for example, Ni, Sn, Ag, Cu, or Ag.

The first external electrode 130 may also include what is called a vapor-deposited film formed by vapor deposition. The material of the vapor-deposited film may be, for example, Ni, Sn, Ag, or Cu.

Since the first external electrode 130 is formable using a sputtered film and/or a vapor-deposited film as described above, the thickness of the first external electrode 130 may be smaller than the thickness of the second external electrode 140. Specifically, the thickness of the first external electrode 130 is preferably 1 μm or greater and 100 μm or smaller, more preferably 5 μm or greater and 50 μm or smaller, still more preferably 10 μm or greater and 30 μm or smaller.

As shown in FIG. 12, the second external electrode 140 is provided on the second end face 110f of the element body 110. In FIG. 11, the second external electrode 140 is provided over the first main face 110a, the second main face 110b, the first side face 110c, and the second side face 110d from the second end face 110f of the element body 110. The second external electrode 140 is electrically connected to the anodes 60 of the elements 1 exposed at the second end face 110f from the element body 110. The second external electrode 140 may be connected to the anodes 60 on the second end face 110f of the element body 110 directly or indirectly.

At least one of the first external electrode 130 or the second external electrode 140 may include a resin electrode layer including a conductive component and a resin component. The conductive component preferably contains, as a main component, a simple metal such as silver, copper, nickel, or tin, an alloy containing at least one of these metals, or the like. The resin component preferably contains an epoxy resin, a phenol resin, or the like as a main component. The resin electrode layer can be formed from a conductive paste such as a silver paste, for example.

At least one of the first external electrode 130 or the second external electrode 140 may have what is called a plating layer formed by a plating method. Examples of the plating layer include a zinc-silver-nickel layer, a silver-nickel layer, a nickel layer, a zinc-nickel-gold layer, a nickel-gold layer, a zinc-nickel-copper layer, and a nickel-copper layer. For example, on one of these plating layers, a copper plating layer, a nickel plating layer, and a tin plating layer are preferably provided in this order (alternatively, except for at least one plating layer).

At least one of the first external electrode 130 or the second external electrode 140 may have both a resin electrode layer and a plating layer. For example, the first external electrode 130 may have a resin electrode layer connected to the current collector electrode 102 and an outer layer plating layer provided on the surface of the resin electrode layer. The first external electrode 130 may also include an inner layer plating layer connected to the current collector electrode 102, a resin electrode layer covering the inner layer plating layer, and an outer layer plating layer provided on the surface of the resin electrode layer. The second external electrode 140 may include a resin electrode layer connected to the anodes 60 and an outer layer plating layer provided on the surface of the resin electrode layer. The second external electrode 140 may also include an inner layer plating layer connected to the anodes 60, a resin electrode layer covering the inner layer plating layer, and an outer layer plating layer provided on the surface of the resin electrode layer.

### Method of Producing Solid Electrolytic Capacitor

The solid electrolytic capacitor 100A shown in FIG. 9 and FIG. 10 can be produced, for example, by connecting the lead frames 170 and 180 to the plurality of solid electrolytic capacitor elements 1, and sealing the surroundings of the plurality of solid electrolytic capacitor elements 1 with a sealant in a resin mold such as a compression mold or a transfer mold to form the sealing body 160.

The solid electrolytic capacitor 100B shown in FIG. 11 and FIG. 12 can be produced by the following method. In the following example, a method of simultaneously producing a plurality of solid electrolytic capacitor elements using a large-sized valve acting metal substrate will be described.

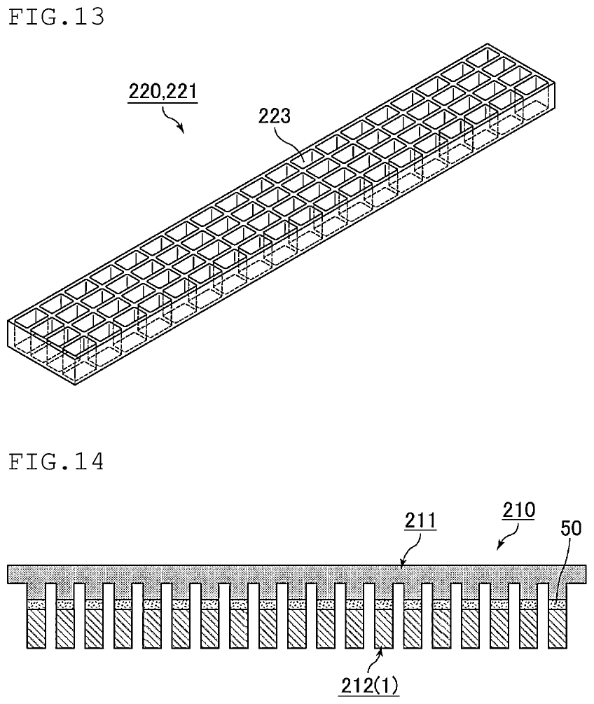

FIG. 13 is a perspective view schematically showing an example of a first portion of an exterior body, showing a state with some through holes seen through.

First, as shown in FIG. 13, a first portion 221 of an exterior body 220 (component to be the first portion 121 of the exterior body 120) including the first resin material above and having a plurality of through holes 223 is prepared. The first portion 221 is a flat plate material having a predetermined thickness and a rectangular shape in a plan view, and has a plurality of through holes 223 formed vertically and horizontally. Each through hole 223 is provided in a direction orthogonal to the main faces of the first portion 221, and both ends thereof are open. The first portion 221 can be formed by injection molding. The first resin material used for the first portion 221 is preferably a resin that can be injection molded. Specifically, thermoplastic resins such as polyphenylene sulfide (PPS), a liquid crystal polymer (LCP), polybutylene terephthalate (PBT), polyimide, or polyamide are preferred. The first resin material may contain, as a reinforcing material, a filler such as silica particles, alumina particles, or metal particles, or fibers such as ceramic fibers. Each inner corner of each through hole 223 in the first portion 221 may be rounded or corner-processed (formed into an inclined surface).

Next, a stacked body 101 is prepared.

FIG. 14 is a plan view schematically showing an example of a workpiece.

First, as shown in FIG. 14, a workpiece 210 is prepared in which element portions 212 (plurality of solid electrolytic capacitor elements 1) like strips are connected at constant intervals to a holding portion 211 having a belt-like shape. A mask 50 is formed on each element portion 212. The workpiece 210 can be formed by the method described above for the method of producing a solid electrolytic capacitor element.

In the first portion 221 above, the same number of through holes 223 having a substantially rectangular parallelepiped shape are formed at the same pitch as the strip-like elements 1 of the workpiece 210. A plurality of lines of such through holes 223 are present in the first portion 221.

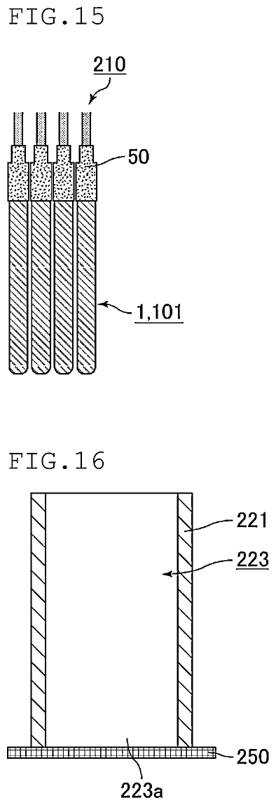

FIG. 15 schematically shows an example of a step of preparing a stacked body with a plurality of solid electrolytic capacitor elements stacked on one another.

Next, as shown in FIG. 15, a plurality of workpieces 210 each including a plurality of elements 1 like strips are prepared. A predetermined number of workpieces 210 are bundled together with the plurality of elements 1 stacked on one another, and then fixed with a jig such as a clamp (not shown). In this manner, a plurality of stacked bodies 101 are produced in each of which a plurality of elements 1 are stacked on one another. The plurality of stacked bodies 101 are arranged in line (a line in a direction perpendicular to the paper surface of FIG. 15).

FIG. 16 schematically shows an example of a step of attaching an adhesive sheet to the first portion of the exterior body.

Next, as shown in FIG. 16, an adhesive sheet 250 (hereinafter, also simply abbreviated as “sheet 250” in some cases) is attached to the first portion 221 so as to close the first opening 223a of each through hole 223. In other words, the adhesive sheet 250 is attached to one entire face of the first portion 221 so as to close one side of each through hole 223. This enables easily exposure of the current collector electrode 102 at the first end face 110e of the element body 110 by peeling off the sheet 250 after sealing.

Each through hole 223 only needs to be in a state where its first opening 223a (lower opening) is covered.

Instead of attaching the adhesive sheet 250, the first opening 223a may be covered, for example, by placing the first portion 221 on a flat table.

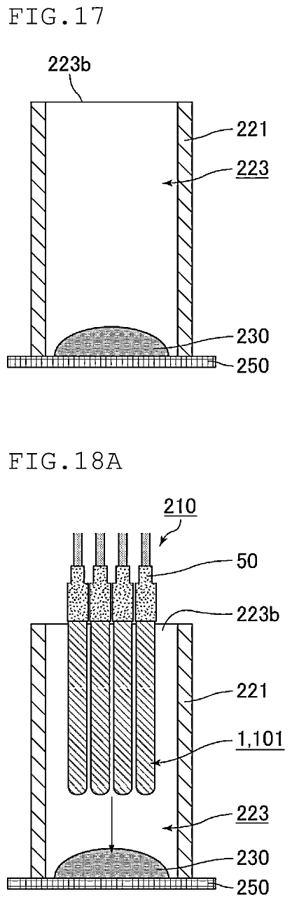

FIG. 17 schematically shows a step of supplying a conductive paste on the adhesive sheet.

Next, as shown in FIG. 17, with the first opening 223a of each through hole 223 covered with the adhesive sheet 250, a conductive paste 230 is supplied onto the sheet 250 from a second opening 223b (upper opening) of the through hole 223. As a result, the conductive paste 230 is applied to the sheet 250 within each through hole 223. The conductive paste 230 may contain, for example, metal particles as a conductive component and a resin component such as an epoxy resin or a phenolic resin. Examples of the metal particles include silver, copper, nickel, and tin particles. The conductive paste 230 is preferably a silver paste containing silver particles as a conductive component. The conductive paste 230 can be supplied using, for example, a dispenser.

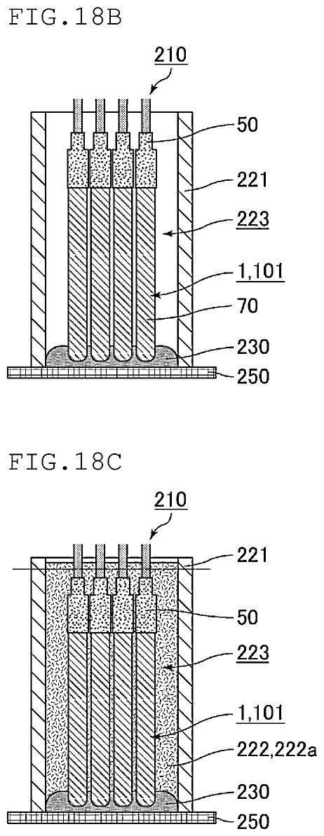

FIG. 18A schematically shows an example of a step of inserting a stacked body into a through hole. FIG. 18B schematically shows an example of a step of embedding the tips of the elements into the conductive paste. FIG. 18C schematically shows an example of a step of filling the space around the elements inserted into the through hole with a liquid material.

Next, as shown in FIG. 18A, the fixed plurality of workpieces 210 are moved relative to the first portion 221 to insert the stacked bodies 101 into the respective through holes 223 in the same line from the second openings 223b.

In this manner, use of the workpieces 210 each including the plurality of elements 1 like strips connected at constant intervals to the holding portion 211 allows the elements 1 to be inserted into the first portion 221 in units of strips. This significantly improves productivity compared with a case of inserting the elements 1 one by one or the stacked bodies 101 one by one into the first portion 221.

At this time, as shown in FIG. 18B, the conductive paste 230 is spread by the tip of each element 1, i.e., the tip of the cathode 70, and the tip of the cathode 70 of each element 1 is embedded in the conductive paste 230. In other words, the conductive paste 230 is connected to all the elements 1.

Then, with each cathode 70 embedded, the conductive paste 230 is cured on the sheet 250 by, for example, heating. As a result, the current collector electrode 102 is formed in a state where at least the tip of the cathode 70 of each element 1 is embedded in the current collector electrode 102 (see FIG. 12).

Next, as shown in FIG. 18C, the space around each element 1 in each through hole 223, i.e., the gap between adjacent elements 1 and the gap between the stacked body 101 and the first portion 221, is filled with the liquid material 222. For example, the liquid material 222 is injected into each through hole 223 using a dispenser or the like, and then vacuum degassing is performed to fill the space around each element 1 with the liquid material 222. Here, the space between the adjacent masks 50 is filled with the liquid material 222 as well. In the case where the adjacent masks 50 are in contact with each other, the liquid material 222 may not be introduced between them. The viscosity of the liquid material 222 may be reduced by heating during injection or vacuum degassing. The liquid material 222 contains the second resin material above (which is in an uncured liquid state). The resin contained in the liquid second resin material is preferably a thermosetting resin such as an epoxy resin, a silicon resin, or a urethane resin. The liquid second resin material may contain, as a reinforcing material, a filler such as silica particles, alumina particles, or metal particles, or fibers such as ceramic fibers.

The liquid material 222 before curing preferably has a viscosity of 100 Pa·s or less at 25° C. With a viscosity of 100 Pa·s or less, the liquid material 222 can be easily introduced by simply degassing and heating in a vacuum oven, which can increase productivity. The viscosity at 25° C. of the liquid material 222 before curing is more preferably 30 Pa·s or less, still more preferably 5 Pa·s or less.

Although there is no lower limit of the viscosity of the liquid material 222 before curing, the viscosity is preferably not too low so that the liquid material 222 does not leak from the gap between the first portion 221 and the sheet 250 between when the liquid material 222 has been introduced and when it is heat-cured. Specifically, the viscosity at 25° C. of the liquid material 222 before curing is usually 0.01 Pa·s or more, preferably 0.1 Pa·s or more, more preferably 0.3 Pa·s or more.

Then, the liquid material 222 filling each of the through holes 223 is cured. For example, the liquid material 222 is heat-cured in a vacuum oven to form a second portion 222a of the exterior body 220 (the portion to be the second portion 122 of the exterior body 120).

The second portion 222a, which is the cured product of the liquid material 222, may contain a few air bubbles trapped. Furthermore, a small gap may be left between the second portion 222a and the first portion 221 and/or between the second portion 222a and at least one element 1.

Then, for each of the other lines of the through holes 223, the conductive paste 230 is supplied, the plurality of elements 1 (stacked body 101) are inserted, the conductive paste 230 is cured, the liquid material 222 is introduced, and the liquid material 222 is cured, so that the plurality of elements 1 (stacked body 101) and the second portion 222a are put in every through hole 223.

Subsequently, after the liquid material 222 has been cured, the sheet 250 is peeled off from the first portion 221. The current collector electrode 102 to which the elements 1 are connected is exposed at the peeled surface. This peeled surface serves as a first end face 110e of the element body 110. The end face of at least one cathode 70 may be exposed at this peeled surface.

At the top of the first portion 221, there are unnecessary portions of the elements 1, an unnecessary portion of the liquid material 222, and the holding portion 211 of the workpiece 210. Furthermore, the height of the first portion 221 is to be the length in the longitudinal direction of a chip, and thus needs to be adjusted to a predetermined length. For this purpose, first, the unnecessary portions at the top of the first portion 221 are shaved off along a predetermined cut line (for example, the dashed and dotted line in FIG. 18C) with a grinder or the like. The surface exposed after the unnecessary portions have been shaved off becomes the second end face 110f of the element body 110. The anode 60 (foil formed from the valve acting metal substrate) of each element 1 is exposed at the second end face 110f.

Next, cutting is performed to obtain individual pieces.

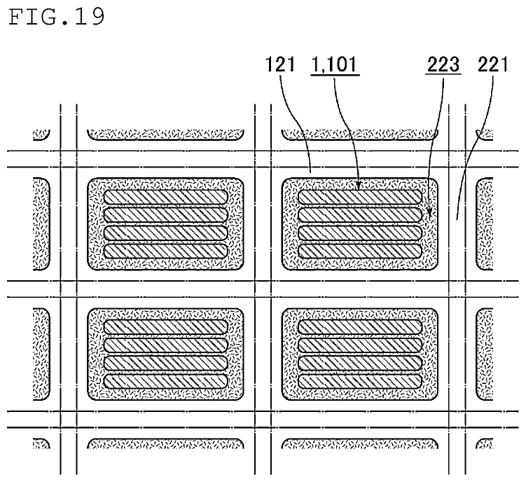

FIG. 19 schematically shows an example of a step of cutting the first portion of the exterior body around each through hole.

As shown in FIG. 19, the first portion 221 around each through hole 223 is cut. This facilitates formation of the first portion 121 having a tube structure using the first portion 221. For example, the first portion 221 is cut along the predetermined cut lines (for example, the dashed and dotted lines in FIG. 19) outside each through hole 223 using a dicer or the like.

In this manner, element bodies 110 each including a stacked body 101 of elements 1 are obtained.

Thereafter, each element body 110 may be subjected to barrel polishing. Specifically, the element body 110 may be polished by enclosing the element body 110 together with an abrasive in a barrel tank and rotating the barrel tank. This rounds the corner portions and ridge portions of the element body 110.

Metal fine particles (for example, Cu fine particles) may be ejected and collided with the second end face 110f (anode end face) of the barrel-polished element body 110 by an aerosol deposition method as needed. As a result, a metal film (contact layer) may be formed on the anode 60 exposed at the second end face 110f (anode end face) of the element body 110.

Next, a first external electrode 130 and a second external electrode 140 are respectively formed on the first end face 110e (cathode end face) and the second end face 110f (anode end face) of the element body 110. For example, a conductive paste is applied by screen printing or the like and then cured to form resin electrode layers as the first external electrode 130 and the second external electrode 140. The conductive paste for forming the resin electrode layers is preferably a silver paste containing silver particles as a conductive component. Thereafter, a plating layer may be formed on each resin electrode layer by plating.

At this time, the first external electrode 130 may be a thin sputtered film and/or a vapor-deposited film having a thickness of several micrometers, for example, formed by sputtering or vapor deposition.

The solid electrolytic capacitor 100B can be obtained by the method above.

Although the case where the current collector electrode 102 is provided has been described here, the current collector electrode 102 may not be provided and the cathode 70 of each solid electrolytic capacitor element 1 may be directly connected to the first external electrode 130. In this case, for example, after peeling off the adhesive sheet 250, the lower part of the first portion 221 to which the sheet 250 was attached may be shaved off with a grinder or the like to expose the cathode 70 at the first end face 110e (cathode end face) of the element body 110, and the first external electrode 130 may be formed on the cathode 70 exposed at the first end face 110e.

Furthermore, in the case where the current collector electrode 102 is not provided, the second portions 222a of the exterior body 220 may be formed according to the following steps. In other words, first, the liquid material 222 is injected into each of the through holes 223 of the first portion 221 with a dispenser or the like to fill the through holes 223. Next, a plurality of solid electrolytic capacitor elements 1 (stacked body 101) are inserted into each of the through holes 223 filled with the liquid material 222, so that the space around each of the inserted elements 1 is filled with the liquid material 222. For example, vacuum degassing is performed after the plurality of elements 1 are inserted to fill the space around each of the elements 1 with the liquid material 222. Then, the liquid material 222 filling each of the through holes 223 is heat-cured in a vacuum oven, for example.

In the embodiment above (in particular, FIG. 11 and FIG. 12), the case is described where the exterior body 120 is made of only two types of resin materials, i.e., consists of the first portion 121 and the second portion 122. The exterior body 120, however, may also be made of three types of resin materials. For example, one or more intermediate resin layers made of a resin material may be provided between the first portion and the second portion of the exterior body. Such an intermediate resin layer can be formed, for example, by forming the second portion, which seals the stacked body of a plurality of solid electrolytic capacitor elements, with dimensions smaller than the through hole of the first portion by transfer molding or the like; inserting the stacked body of a plurality of solid electrolytic capacitor elements together with the second portion into the through hole of the first portion; and filling the gap between the second portion and the first portion with a liquid resin material and curing the material.

Conversely, the exterior body 120 may be made of only one type of resin material. For example, the first portion 121 may not be provided and only the second portion 122 may be provided. Such a solid electrolytic capacitor can be produced, for example, by setting the cut lines inside each through hole 223 in the cutting step for individualization, and cutting and removing the entire first portion 221.

Furthermore, in the embodiment above (in particular, FIG. 11 and FIG. 12), the case has been described where a substantially rectangular parallelepiped shaped element body 110 is used. However, in the solid electrolytic capacitor 100B shown in FIG. 11 and FIG. 12, the element body may have any shape having a first end face and a second end face facing each other, and the shape may be, for example, a cylindrical shape in addition to the substantially rectangular parallelepiped shape.

In addition, in the embodiment above (in particular, FIG. 13 to FIG. 19), the case has been described where a plurality of element bodies 110 are simultaneously produced using the first portion 221 with the plurality of through holes 223. Element bodies may also be produced one by one using a first portion of an exterior body with only one through hole.

### EXAMPLES

Hereinafter, an example more specifically disclosing the solid electrolytic capacitor element, the solid electrolytic capacitor, and the method of producing a solid electrolytic capacitor of the present disclosure will be described. The present disclosure is not limited only to the example.

### Example

A plurality of solid electrolytic capacitors were produced each of which was the same as the solid electrolytic capacitor 100A shown in FIG. 9 and FIG. 10. Each of the solid electrolytic capacitors had a defect in the solid electrolyte layer near the first portion of the mask.

### Comparative Example

A plurality of solid electrolytic capacitors were produced as in the example, except that the second portion of the mask was not formed. Each of the solid electrolytic capacitors in the comparative example had a defect in the solid electrolyte layer near the first portion of the mask.

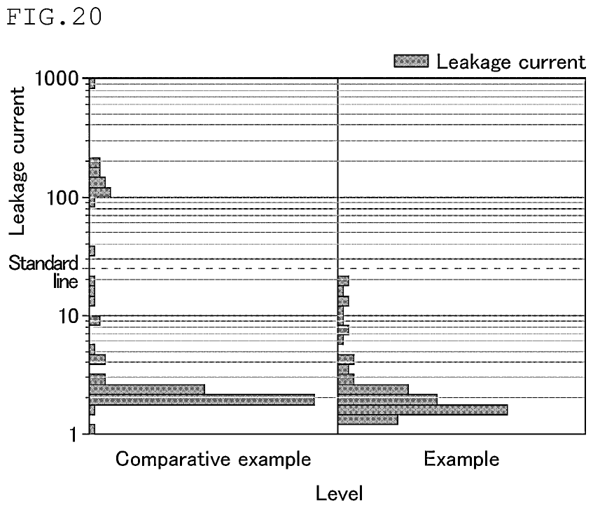

FIG. 20 is a graph showing the results of measuring leakage currents of the solid electrolytic capacitors of an example and a comparative example. In FIG. 20, the vertical axis indicates the magnitude (logarithm) of the leakage current, and the horizontal axis indicates the number of solid electrolytic capacitors that exhibited the leakage current on the vertical axis.

As shown in FIG. 20, in the example in which the mask with the first portion and the second portion was provided, even through the solid electrolyte layers had a defect, the leakage current was kept below the standard value (see the standard line in the figure), and the occurrence of leakage current defects was successfully prevented.

On the other hand, in the comparative example in which the mask with only the first portion was provided, some solid electrolytic capacitors exhibited a leakage current exceeding the standard value (see the standard line in the figure).

The present description discloses the following.

### Disclosure (1)

A solid electrolytic capacitor element including: a valve acting metal substrate including a metal substrate layer and a porous layer on the metal substrate layer and having an anode terminal region and a cathode formation region; a dielectric layer on a surface of the porous layer in the cathode formation region; a solid electrolyte layer on the dielectric layer in the cathode formation region; a conductive layer on the solid electrolyte layer; and a mask having: a first portion dividing the valve acting metal substrate into the anode terminal region and the cathode formation region and in direct contact with the porous layer or in indirect contact with the porous layer via the dielectric layer, a second portion covering the solid electrolyte layer on the porous layer, and the mask does not cover the conductive layer.

### Disclosure (2)

The solid electrolytic capacitor element according to Disclosure (1), wherein the second portion covers the solid electrolyte layer to a point at least 50 μm away from an edge of the first portion adjacent to the cathode formation region.

### Disclosure (3)

The solid electrolytic capacitor element according to Disclosure (1) or (2), wherein the second portion does not cover the solid electrolyte layer at any point more than 500 μm away from the edge of the first portion adjacent to the cathode formation region.

### Disclosure (4)

The solid electrolytic capacitor element according to any one of Disclosures (1) to (3), wherein the second portion covers at least a part of the first portion.

### Disclosure (5)

The solid electrolytic capacitor element according to any one of Disclosures (1) to (4), wherein a thickness of the solid electrolyte layer nearest the first portion is smaller than a thickness of the solid electrolyte layer in a central portion of the solid electrolyte layer.

### Disclosure (6)

The solid electrolytic capacitor element according to any one of Disclosures (1) to (5), wherein the first portion and the second portion are on at least one main face of the valve acting metal substrate.

### Disclosure (7)

The solid electrolytic capacitor element according to Disclosure (6), wherein the first portion and the second portion are in an annular pattern surrounding the valve acting metal substrate.

### Disclosure (8)

A solid electrolytic capacitor comprising a plurality of solid electrolytic capacitor elements each of which is the solid electrolytic capacitor element according to any one of Disclosures (1) to (7).

### Disclosure (9)

A method of producing a solid electrolytic capacitor element, including: forming a first portion of a mask directly on a porous layer of a valve acting metal substrate or indirectly on the porous layer of the valve acting metal substrate via a dielectric layer, the first portion dividing the valve acting metal substrate into an anode terminal region and a cathode formation region; forming, after the forming of the first portion, a solid electrolyte layer on the dielectric layer in the cathode formation region; and forming, after the forming of the solid electrolyte layer, a second portion of the mask covering the solid electrolyte layer.

### REFERENCE SIGNS LIST

1 solid electrolytic capacitor element
10, 10A valve acting metal substrate
10a side of valve acting metal substrate
11 metal substrate layer
11a one end face of metal substrate layer
12 porous layer
12a outermost surface of porous layer
13 anode terminal region
14 cathode formation region
15 element portion
16 support portion
20 dielectric layer
30 solid electrolyte layer
40 conductive layer
50 mask
51 first portion of mask
51a end of first portion of mask adjacent to cathode formation region
52 second portion of mask
60 anode
70 cathode
80 treatment liquid
85 treatment tank
100A, 100B solid electrolytic capacitor
101 stacked body
102 current collector electrode
110 element body
110a first main face
110b second main face
110c first side face
110d second side face
110e first end face
110f second end face
120 exterior body
121 first portion of exterior body
122 second portion of exterior body
123 through hole
130 first external electrode
140 second external electrode
160 sealing body
170, 180 lead frame
210 workpiece
211 holding portion
212 element portion
220 exterior body
221 first portion of exterior body
222 liquid material
222a second portion of exterior body
223 through hole
223a first opening
223b second opening
230 conductive paste
250 adhesive sheet
W width of second portion of mask
T1 thickness of solid electrolyte layer near first portion of mask
T2 thickness of solid electrolyte layer in central portion of solid electrolyte layer

1. A solid electrolytic capacitor element comprising:
a valve acting metal substrate comprising a metal substrate layer and a porous layer on the metal substrate layer and having an anode terminal region and a cathode formation region;
a dielectric layer on a surface of the porous layer in the cathode formation region;
a solid electrolyte layer on the dielectric layer in the cathode formation region;
a conductive layer on the solid electrolyte layer; and
a mask having:
a first portion dividing the valve acting metal substrate into the anode terminal region and the cathode formation region and in direct contact with the porous layer or in indirect contact with the porous layer via the dielectric layer,
a second portion covering the solid electrolyte layer on the porous layer, and
the mask not covering the conductive layer.

2. The solid electrolytic capacitor element according to claim 1, wherein the second portion covers the solid electrolyte layer to a point at least 50 μm away from an edge of the first portion adjacent to the cathode formation region.

3. The solid electrolytic capacitor element according to claim 2, wherein the second portion does not cover the solid electrolyte layer at any point more than 500 μm away from the edge of the first portion adjacent to the cathode formation region.

4. The solid electrolytic capacitor element according to claim 1, wherein the second portion does not cover the solid electrolyte layer at any point more than 500 μm away from an edge of the first portion adjacent to the cathode formation region.

5. The solid electrolytic capacitor element according to claim 1, wherein the second portion covers at least a part of the first portion.

6. The solid electrolytic capacitor element according to claim 1, wherein a thickness of the solid electrolyte layer nearest the first portion is smaller than a thickness of the solid electrolyte layer in a central portion of the solid electrolyte layer.

7. The solid electrolytic capacitor element according to claim 1, wherein the first portion and the second portion are on at least one main face of the valve acting metal substrate.

8. The solid electrolytic capacitor element according to claim 7, wherein the first portion and the second portion are in an annular pattern surrounding the valve acting metal substrate.

9. The solid electrolytic capacitor element according to claim 1, wherein the first portion is in direct contact with the porous layer.

10. The solid electrolytic capacitor element according to claim 1, wherein the first portion is in direct contact with the dielectric layer.

11. The solid electrolytic capacitor element according to claim 1, wherein the first portion does not cover the solid electrolyte layer.

12. A solid electrolytic capacitor comprising a plurality of solid electrolytic capacitor elements each of which is the solid electrolytic capacitor element according to claim 1.

13. A method of producing a solid electrolytic capacitor element, the method comprising:
forming a first portion of a mask directly on a porous layer of a valve acting metal substrate or indirectly on the porous layer of the valve acting metal substrate via a dielectric layer, the first portion dividing the valve acting metal substrate into an anode terminal region and a cathode formation region;
forming, after the forming of the first portion, a solid electrolyte layer on the dielectric layer in the cathode formation region; and
forming, after the forming of the solid electrolyte layer, a second portion of the mask covering the solid electrolyte layer.

14. The method of producing the solid electrolytic capacitor element according to claim 13, wherein the first portion and the second portion are formed so as to not cover a conductive layer of the solid electrolytic capacitor.

15. The method of producing the solid electrolytic capacitor element according to claim 13, wherein the second portion is formed so as to cover the solid electrolyte layer to a point 50 μm to 500 μm away from an edge of the first portion adjacent to the cathode formation region.

16. The method of producing the solid electrolytic capacitor element according to claim 13, wherein the second portion is formed so as to cover at least a part of the first portion.

17. The method of producing the solid electrolytic capacitor element according to claim 13, wherein the first portion is formed in direct contact with the porous layer.

18. The method of producing the solid electrolytic capacitor element according to claim 13, wherein the first portion is formed in direct contact with the dielectric layer.

19. The method of producing the solid electrolytic capacitor element according to claim 13, wherein the first portion is formed so as to not cover the solid electrolyte layer.
